(19) United States
(12) Patent Application Publication
(10) Pub. No.: US 2008/0040126 A1
(43) Pub. Date: Feb. 14, 2008

(54) Social Categorization in Electronic Mail

(75) Inventors: Julio Estrada, Medina, WA (US); Alexis Campailla, Seattle, WA (US)

Correspondence Address: SENNIGER POWERS (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/463,156

(22) Filed: Aug. 8, 2006

(51) Int. Cl. G06Q 10/00; G06Q 30/00

(52) U.S. Cl. 705/1

(57) ABSTRACT

Associating communication objects based on the content of the communication objects using social category tags. Communication objects are collected for a user. Each communication object has a type describing characteristics of each said communication object. An instruction is received from the user for assigning a social category tag to each one of the collected communication objects. A subset of the collected communication objects is associated based on their assigned tags. The associated subset of communication objects is presented to the user such that more than one type of communication objects is included in the subset.

### BACKGROUND

The advances in computer technology and the Internet leap technology users into an information age when the users possess numerous ways to communicate with others. For example, digital cellular phones, electronic mail (“e-mail”), personal digital assistant (PDA), or the like keep people “wired” at all times. While these convenient tools keep people “connected” frequently, users also spend considerable amount of time sorting, organizing, and filtering the information (e.g., tasks, appointments, contact entries) or messages (e.g., e-mail messages). Using e-mail as an example, users first need to filter out wanted and unwanted messages (e.g., spam). The users next would need to organize the wanted messages into different categories.

In organizing these messages, existing practices require users create directories or folders to organize messages by source, subject, or content. For example, a user may organize all e-mail messages from his or her father into a folder titled “father.” In another example, the communication software, such as an e-mail client application, may create a default folder such as “contacts” or “address book” for storing contact information of e-mail recipients. Other default folders may include a folder for calendar events, tasks, appointments, and the like. Another existing practice is where users would conduct a query of all received items, and the users would create a folder to include queried results.

While these efforts, both on the part of the users and the respective applications, aim to provide the user an easy and fast way to organize messages and information, these practices expose fundamental flaws and shortcomings associated with these practices. For example, in the practice where users/applications create folders for organizing messages or information, each of the folders could only store one type of message or information. In this example, a typical folder within the communication software could only store e-mail messages, not appointment requests, task items, or calendar events. Those different types of messages would be organized in the specially created folders. As such, the users who would like to organize messages and information related a particular project would be required to look into different folders to find all the information associated with the particular project.

In addition, the shortcomings for the practice of creating folders based on queried results assume users can create most relevant query terms to gather all messages. However, such assumption sometimes may be unreasonable, and even such practice would not retrieve all related information, such as contacts (e.g., person's contact information) associated with the particular project.

### SUMMARY

Embodiments of the invention overcome the deficiencies of previous systems and practices by assigning social category tags to communication objects and information such that users can freely associate various types of communication objects and information based on the tags. Alternative embodiments enable server-side applications to aggregate the social category tags created by one user and present the social category tags to another user such that a collaboration of tags among users can be created.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating a system for associating various types of communication objects via social category tags according to an embodiment of the invention.

FIG. 2 is a block diagram illustrating a data structure of a social category tag according to an embodiment of the invention.

FIGS. 3A to 3J are screen shots illustrating a user interface associated with the use of social category tags according to an embodiment of the invention.

FIG. 4 is a block diagram illustrating a distributed system for associating various types of communication objects from one or more users via social category tags according to an embodiment of the invention.

FIG. 5 is a flow chart illustrating operations of associating communication objects based on the content of the communication objects according to an embodiment of the invention.

Corresponding reference characters indicate corresponding parts throughout the drawings.

### DETAILED DESCRIPTION

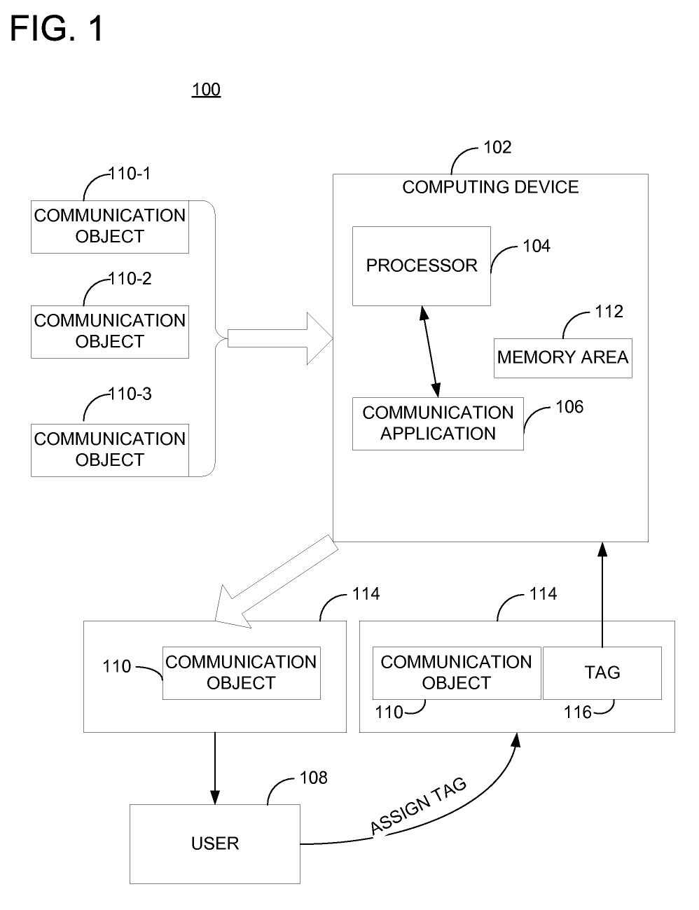

Referring first to FIG. 1, a block diagram illustrates a system 100 for associating various types of communication objects via social category tags according to an embodiment of the invention. For example, system 100 includes a computing device 102, such as a computer (e.g., a personal computer or a server computer), a personal digital assistant (PDA), a cellular phone, or other computing devices. The computing device 102 also includes a processor 104 or one or more processing units for processing computer-executable instructions, codes, software, application, or routines. In one example, the process 104 executes a communication application 106 which handles and processes communication objects 110 for a user 108. In one embodiment, the communication objects 110 include one or more of the following types: e-mail messages, user contact entries, task items, electronic appointment requests, instant messaging conversations, electronic notes, and other types of electronic messages. In one embodiment, the communication objects 110 include other electronic files or data associated with the e-mail messages, user contact entries, task items, electronic appointment requests, instant messaging conversations, and electronic notes. In yet another example, the types of communication objects are determined by the content (e.g., e-mail message), by the protocols in which the communication objects use (e.g., instant message conversations), or by the types of operations (e.g., an action item) that may be performed on the communication objects.

For example, a contact entry is a type of communication objects 110 different from an e-mail message, because the user 108 operates the contact entry by inserting contact information of an individual, such as name, e-mail address, home phone number, or the like. In the same token, an electronic appointment request is a different type of communication objects from a task item, because the user 108 handles the appointment request by accepting or rejecting the request when his or her appointment schedule permits such appointment at the requested time and date. On the other hand, the user 108 operates or handles the task item by accepting or declining the task when he or she is able to perform the task before the deadline.

In another example, the communication objects 110 may include an attached file associated with the e-mail received or sent by the user 108. Furthermore, an activity in a workflow may also be a type of communication objects 1 10. In another embodiment, communication application 106 may include application programming interfaces (APIs) such that other software, application, application components may handle the communication objects 110 and/or files or data associated with the communication objects 110 (such as file attachments) in conjunction with the communication application 106.

Still referring to FIG. 1, the computing device 102 also includes a memory area 112 for storing data, such as files and tags 1 16. In one embodiment, the memory area 112 includes some form of computer readable media. Computer readable media, which include both volatile and nonvolatile media, removable and non-removable media, may be any available medium that may be accessed by the computing device 102. By way of example and not limitation, computer readable media comprise computer storage media and communication media. Computer storage media include volatile and nonvolatile, removable and non-removable media implemented in any method or technology for storage of information such as computer readable instructions, data structures, program modules or other data.

For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by the computing device 102. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

As known to those who are familiar with operating files or communication objects in a computer or a computing device, one of the challenges is to locate and organize these files or objects. Previous practices require users to create folders or directories to organize objects by associating one or more characteristics related to the objects. For example, in an operating system environment, a user may create a folder named “Applications” to include all applications or software used by the user. The user may further create a hierarchical structure of folders to further refine file organization or classification. For example, under the “Applications” folder, the user may have one or more folders each having files associated with a particular software or application.

In this setting, each of the folders may include a variety of file types, ranging from a text file, a media file, an executable file, or the like. Each folder would include only an instance of the file. In other words, one file may only be referenced by one identifier. For example, a file “File_A” stored in the folder “Applications” is identified by its path: “Applications\File_A” and it may not substantially simultaneously exist in another folder such as “Applications\Word_Processor”.

Applying the same practice to the communication application 106, existing scheme of organizing communication objects 110 inside the communication application 106 follows this one-to-one relational classification. For example, suppose an e-mail message is organized in a “co-worker” folder, another instance of the same message cannot be stored in a folder called “project_A”. Another disadvantage of the existing organization scheme is that various types of the communication objects 110 cannot be organized within one folder. For example, the communication application 106 could not store or organize an e-mail message and a contact entry within the same folder. While the communication application 106 can convert all types of communication objects as a form of message, the communication application 106 nevertheless cannot store or organize the types of communication objects separately based on their types.

For example, the communication application 106 typically includes a folder called “SENT ITEM” or “SENT FOLDER” or “INBOX”. While this “SENT ITEM” or “INBOX” folder appears to store all types of communication objects 110, the user 108 could not operate or handle the various types of communication objects 110. In other words, the objects in this folder are representations of messages carrying the various types of communication objects 110 to the respective destination or recipients. The folder does not store the various types of communication objects 110. Once the user 108 processes (i.e., receives the message and accepts the task item or agrees to participate in an appointment) the communication objects 110 in the folder, different types of the communication objects 110, for example, would be automatically removed from the “INBOX” folder.

Embodiments of the invention overcome such limitations and shortcomings by enabling the user 108 to assign tags to communication objects 110. These tags enable the user 108 to associate various types of communication objects 110 based on the tags such that a multi-relational classification is created. For example, the user 108 may create more than one tag referencing one e-mail message, such as an e-mail message may include a tag “co-work” and another tag “project A” at the same time. Alternative embodiments of the invention enable a plurality of users sharing or associating individually created tags in a distributed network environment. Based on the assigned tags, a subset of the collected communication objects 110 is created. In addition, through the assigned tags, one communication object is referenced in more than one subset.

For example, as the communication application 106 receives one or more communication objects 110, the communication application 106 presents the communication objects 110 to the user 108 via a user interface (UI) 114 (e.g., a display, or a graphical user interface (GUI)). Upon receiving the communication objects 110, the user 108 interacts (e.g., visually or audibly) with the communication objects 110 via one or more input means or devices. The user 108 may then assign a tag 116 to one of the communication objects 110 based on the content of the communication objects 110 or other personal preference. In one embodiment, the tag 116 may be metadata describing one or more characteristics of the communication objects 110. Other types of representation of the tag 116 (e.g., hypertext links, hypertext, dynamic scripts, etc.) may be used without departing from the scope of the invention. In an alternative embodiment, the tag 116 is more than a file extension associated with a file because a file cannot simultaneously have more than one file extension.

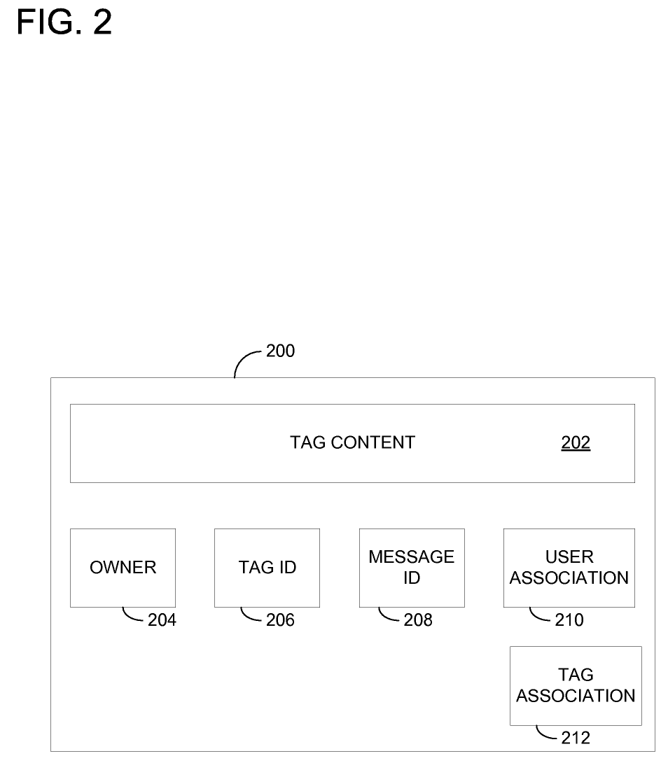

Referring now to FIG. 2, block diagram illustrates a data structure 200 of a social category tag according to an embodiment of the invention. For example, the data structure 200 includes data or metadata describing a first data field 202, which includes content of the social category tag. For example, the user 108 may include “project 101” as the tag content in the first data field 202. In another embodiment, the first data field 202 may include multiple tag content, such as “project 101” and “my best co-workers”.

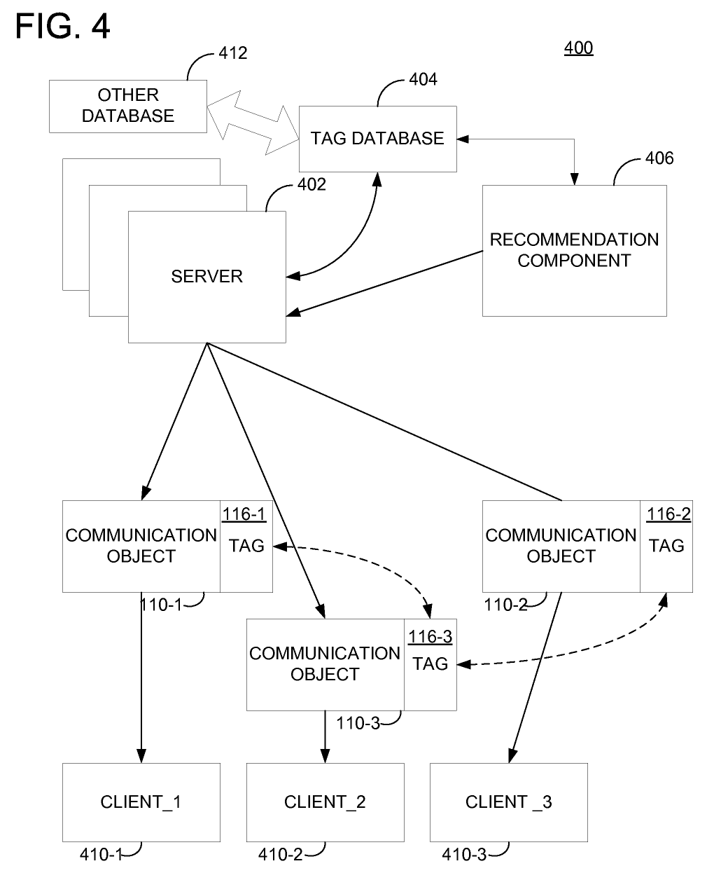

The data structure 200 further includes a second data field 204 including data or metadata identifying the owner/user of the communication object. A third data field 206 includes data or metadata identifying a tag (e.g., using a tag identification (ID)) associated with the communication object. Using the example above, the “project 101” and “my best co-workers” tags may each include a unique tag ID identifying the tags such that the communication application 106 may uniquely identify the tags and use the tags among different users (to be discussed further in detail in FIG. 4).

The data structure 200 also includes a fourth data field 208 including data or metadata identifying the communication object 110 using a message ID. A fifth data field 210 includes data or metadata identifying one or more user associated with the owner/user of the communication object 110. For example, suppose USER_A sends an e-mail message to two recipients, USER_B and USER_C. The fifth data field 210 would include data (e.g., name and/or e-mail address) of USER_B and USER_C. Alternative embodiments may make recommendation of the assigned tag to users identified in the fifth data field 210 (e.g., USER_B and USER_C). As such, USER_B and USER_C may learn about USER_A's tag when they receive the e-mail message from USER_A and may assign the recommended or suggested tag in their computing environment.

In another example, the fifth data field 210 includes data relating to the one or more other users as a function of the parameters of the communication object 110. In this example, parameters of the communication object 110 may include recipients of an e-mail message, an assignee of a task, an invitee to or a participant of a meeting, or an individual of a contact entry.

In another alternative embodiment, the data structure 200 further includes a sixth data field 212 including data or metadata identifying tag association data, and the tag association data is determined as a function of at least the content of the communication object 110 and the first data field 204. For example, suppose a user receives an e-mail message from a sender and subsequently assigns a tag “project A” to the message. When the user responds to the message, the tag “project_A” would automatically be assigned to the response because the sixth data field 212 associates the tag “project_A” with the response as a function of at least the content of the communication object 110 and the user.

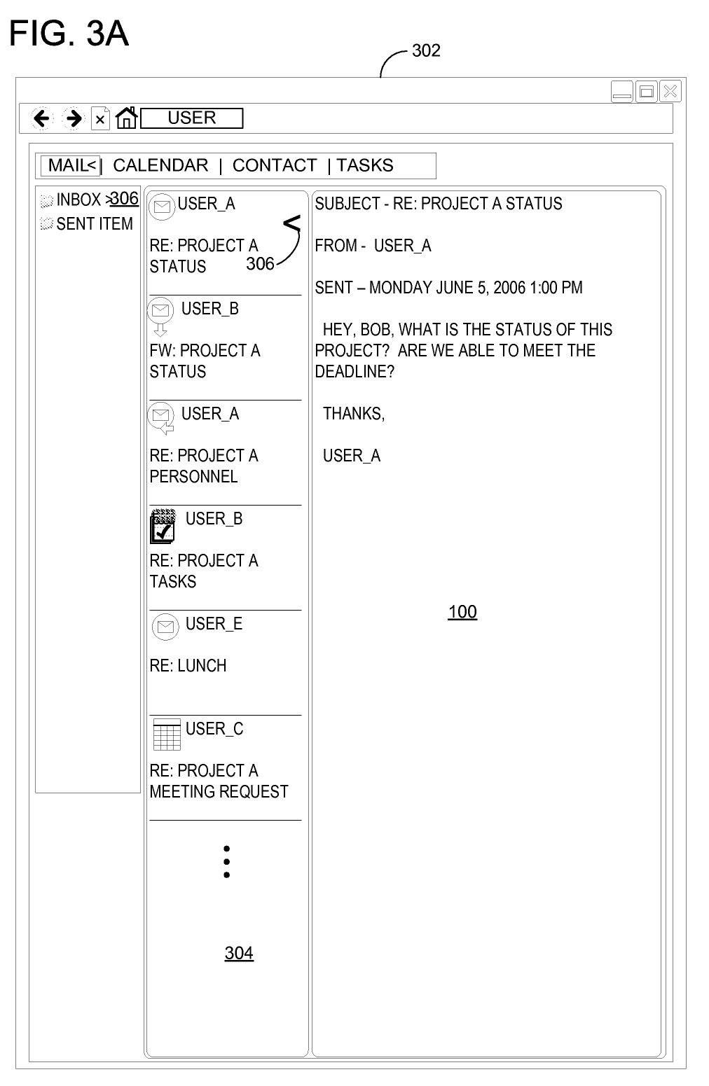

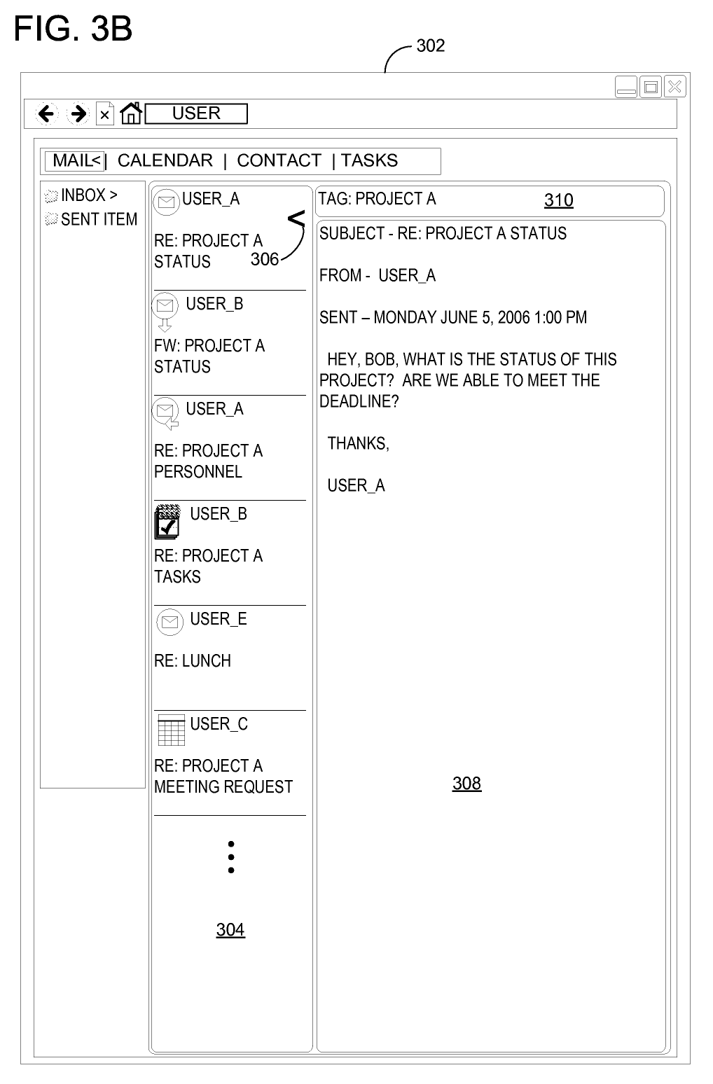

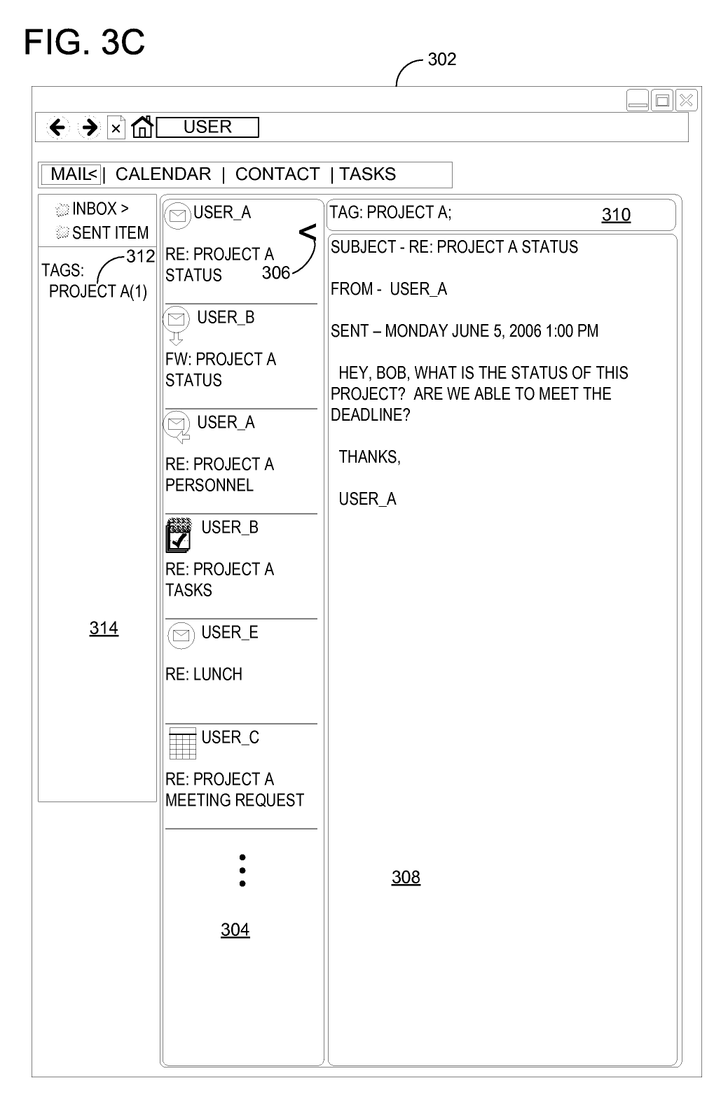

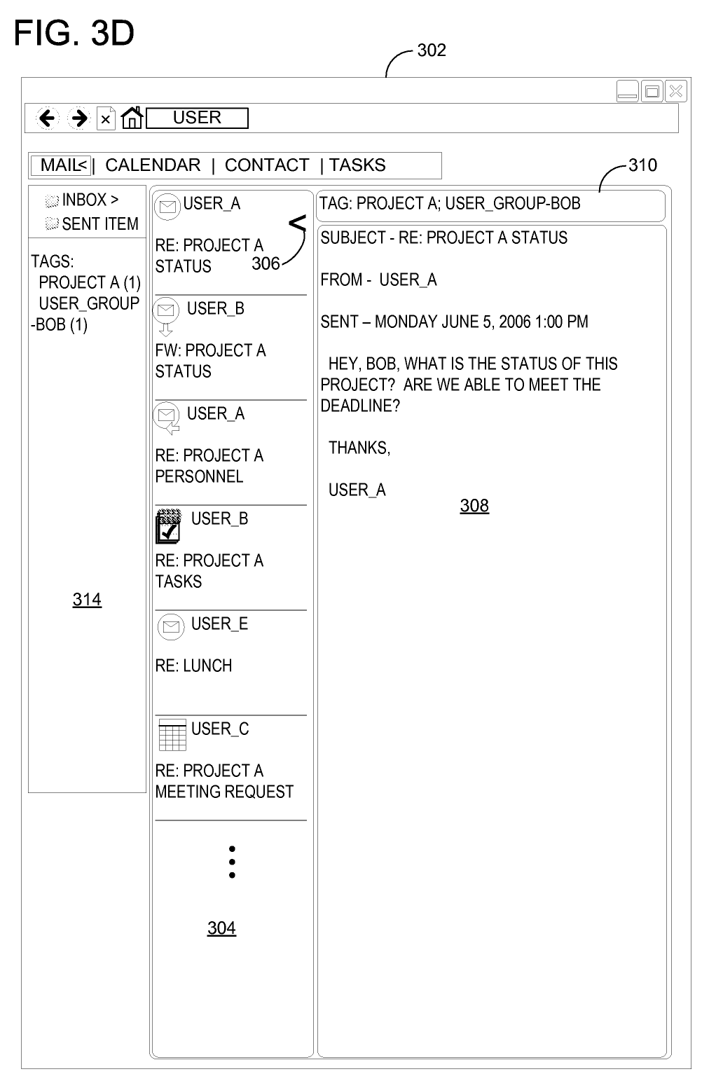

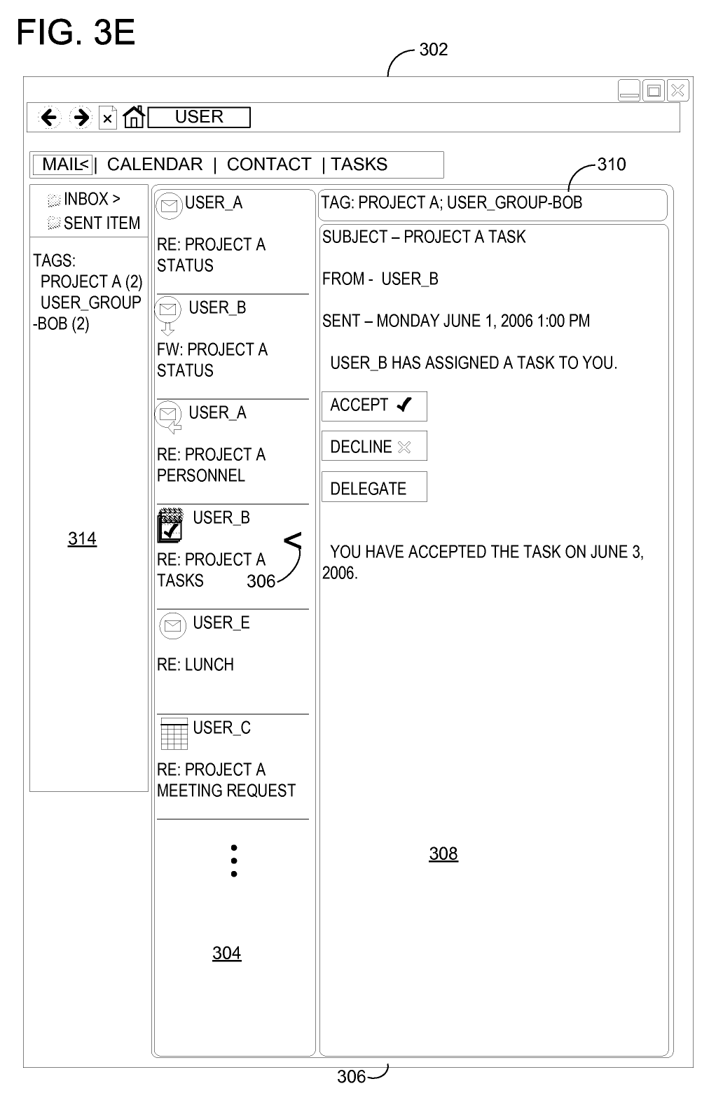

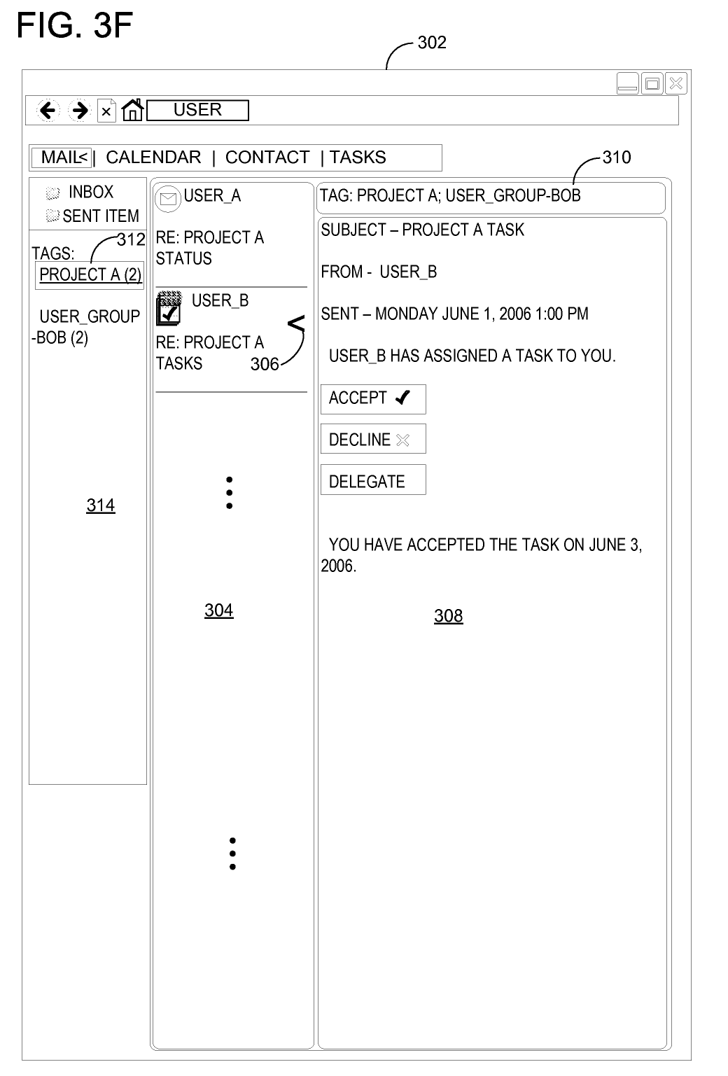

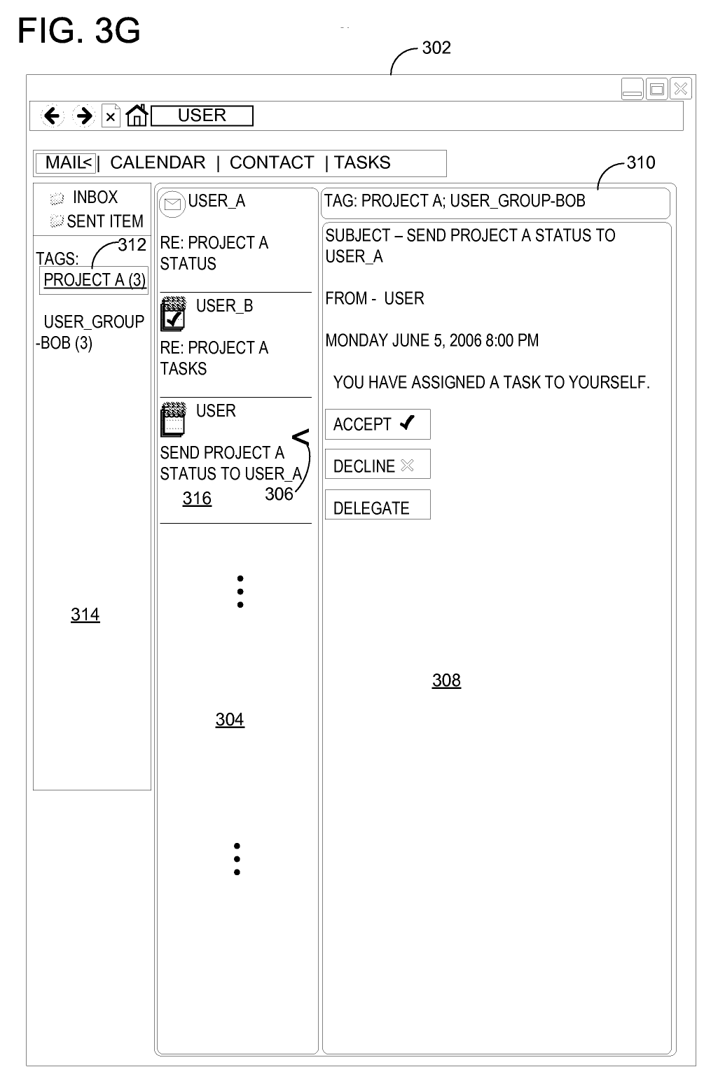

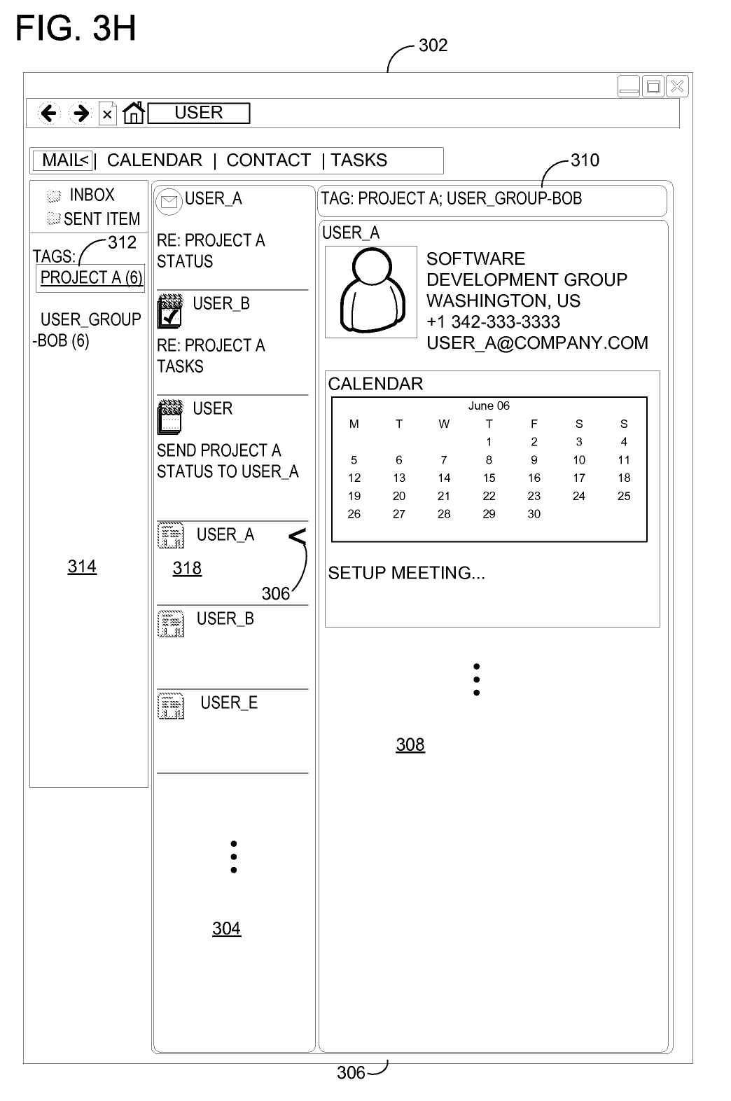

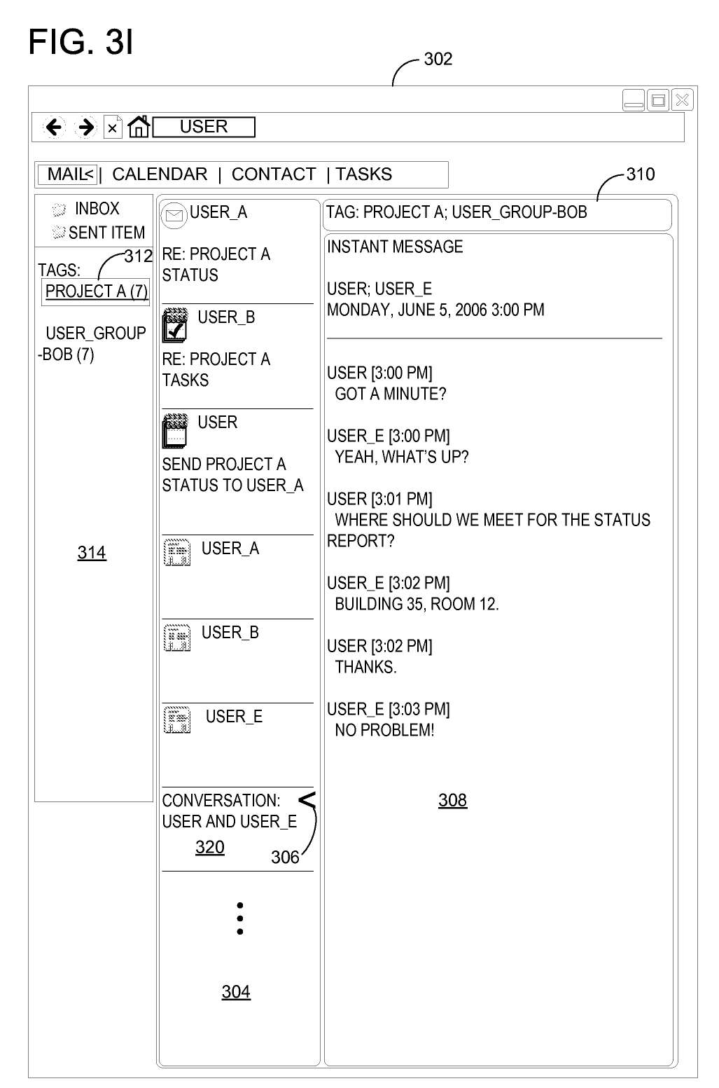

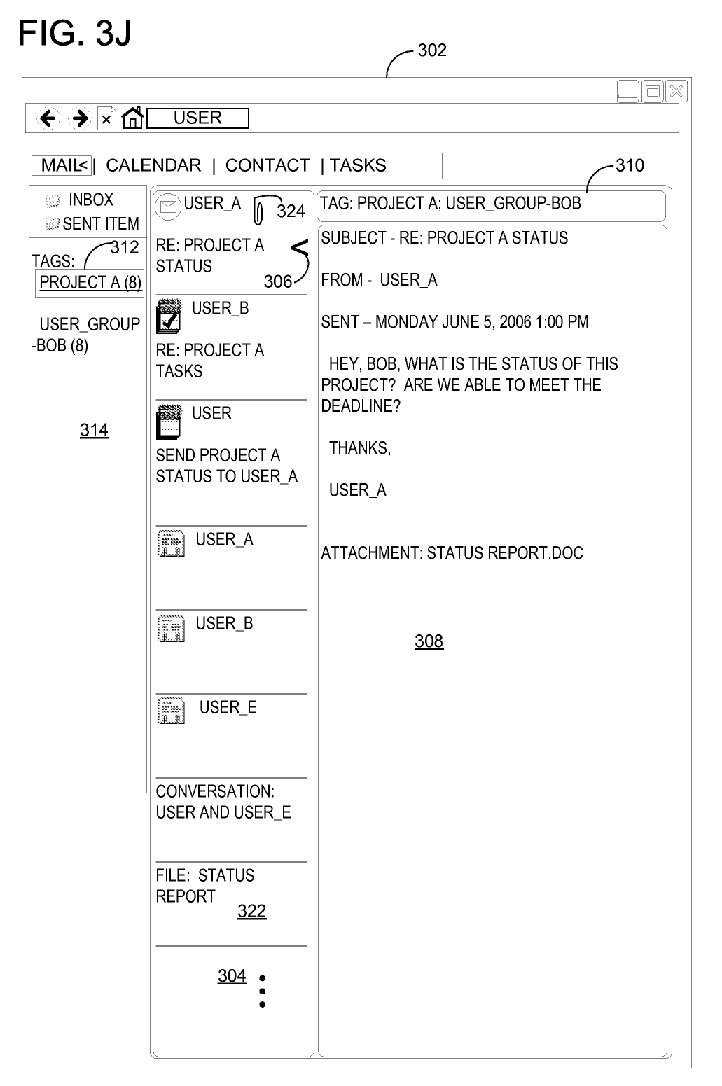

FIGS. 3A to 3J illustrate screen shots of a UI 302 associated with the use of social category tags according to an embodiment of the invention. In one example, the UI represents a GUI of the communication application 106 with which the user 108 interacts. In one example, the communication application 106 is an e-mail client application which is able to handle and process e-mail messages, manage contact entries, organize calendar events, or the like. In another embodiment, the communication application 106 may be a messaging client application that provides a comprehensive time and information management in prioritizing, organizing and searching information.

In FIG. 3A, the user 108 receives one or more communication objects 110 shown on a message pane 304. These objects 110 are currently stored in the “INBOX” folder (as indicated by a symbol “<”). In this example, a highlight arrow 306 indicates that a communication object 110 is selected by the user 108, and that the content of the selected communication object 110 is displayed or presented to the user 108 in a reading pane 308.

Referring now to FIG. 3B, the user 108 assigns a tag “PROJECT A” in a tag field 310 to the communication object 110 highlighted by the highlight arrow 306. As this tag assignment is made, a tag identification 312 is displayed in a location pane 314 showing the tag association in FIG. 3C. In other words, through the creation, generation or assignment of the tag “PROJECT A,” the communication application 106 recognizes such data or metadata associated with the communication object 110 and creates a category in the location pane 314 for the user 108. In one embodiment, the tag identification 312 also includes information such as the number of objects that are associated with the tag. In this example, the number of objects associated with the tag is 1. In one embodiment, related tags or tags inherited from related communication objects may be assigned to the communications objects automatically or at a pre-determined time interval.

In FIG. 3D, another category tag “USER_GROUP-BOB” is presented to the user 108. This category tag, however, is not generated or assigned by the user 108. Instead, the communication application 106 creates or recommends this new tag in the tag field 308 because the sender (e.g., USER_A) assigned this tag to the communication object 110. Once enabled, embodiments of the invention allow communication application 106 to discover tags assigned by other users to create a social categorization of communication objects 108 where assigned tags are shared among users within the same working group, same enterprise, or the like. As such, embodiments of the invention enable multi-relational association of communication objects such that a communication object is referenced simultaneously by more than one tag. At the same time, related communication objects may inherit tags assigned by other users or the user himself or herself.

Referring now to FIG. 3E, the user 108 assigns the same tags (i.e., “PROJECT A” and “USER_GROUP-BOB”) to another type of communication object 110. In this example, the user 108 assigns the tags to a task item identified by the highlight arrow 306. As indicated above, embodiments of the invention enable association or organization of various types of communication objects. Unlike existing practice of organizing objects using folders, social category tags 116 organize and associate types of communication objects without the limitations associated with folders. As illustrated by FIG. 3F, the tag “PROJECT A” highlighted by 312 currently includes an e-mail message and an accepted tag (highlighted by arrow 306).

FIG. 3G illustrates a screen shot in which the user 108 creates a new task item 316 assigning the user 108 to complete a task related to the tag category “PROJECT A” and “USER_GROUP-BOB”. In another example, the user 108 assigns the tag “PROJECT A” and “USER_GROUP-BOB” to a new contact entry 318 (highlighted by arrow 306) in FIG. 3H. Such contact entry 318 displays the information included in the contact entry 318 in the reading pane 308. In yet another example, the user 108 assigns the same tags to a new instant message conversation 320 in FIG. 3I. In addition, in FIG. 3J, an attached file 322 (indicated by an icon 324 included in the message highlighted by arrow 306) may also be associated with the social category “PROJECT A” and “USER_GROUP-BOB”.

In another embodiment, category tags may be recommended to the user 108 based on one or more of the following factors to determine a measure of “closeness”: frequency of contacts between the user 108 and intended recipients, the nature of association between the user 108 and the intended recipients, and the basis of relationship between the user 108 and the intended recipients. In an alternative embodiment, the measure of “closeness” may be measured by a frequency of e-mail exchange: 1. frequent responses; 2. sporadic responses; 3. no response (i.e., never replied); 4. Sender/recipient not on the contact list (i.e., strangers), 5. timing of the response, or the like.

For example, suppose the user 108 maintains one or more contact lists, and each contact list includes contact information associated with individuals. For example, the user 108 may include a contact list “Engineers” for co-workers in her group, while the user 108 may have a list titled “Boss” for her superiors, a list titled “Family” for her family members, a list titled “Pals” for her close friends, or the like.

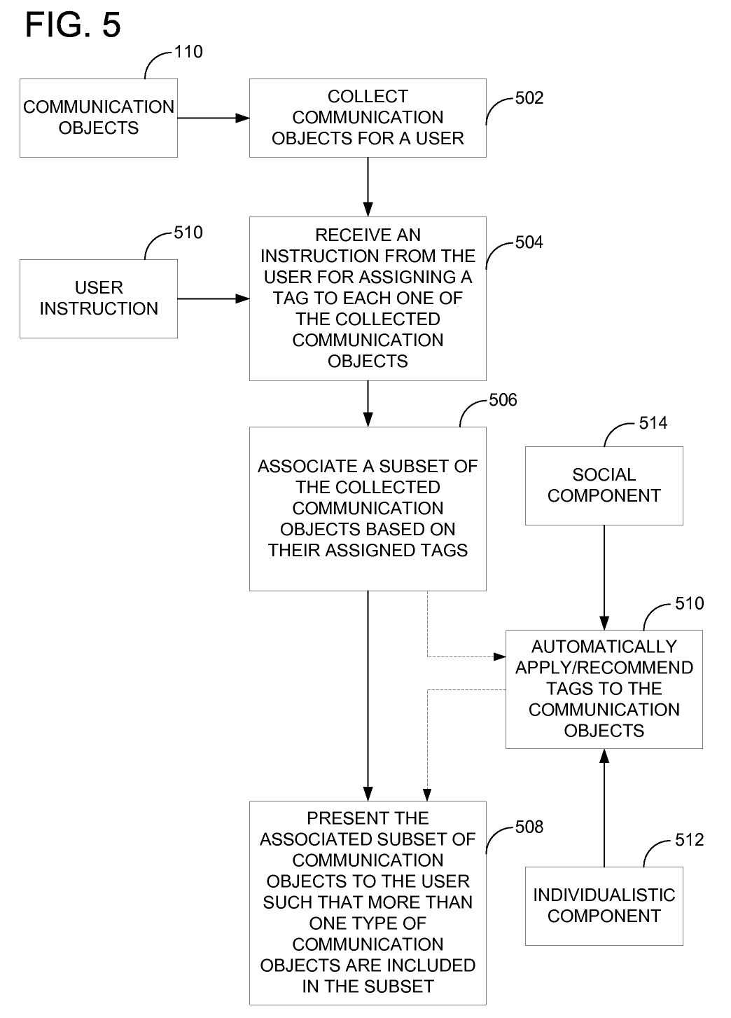

As the user 108 communicates with individuals in each contact list, embodiments of the invention monitor a frequency of communications between the user 108 and the individuals. In another embodiment, a recommendation component 406 (to be described further below in FIG. 4) or a social component 514 (to be described further below in FIG. 5) may monitor or may be coupled with other software application or software that tracks/monitors a frequency of communication between the user 108 and the members in the contact lists. In another example, based on the frequency of communication, embodiments may recommend category tags to the user 108. For example, a tag “Project” may be recommended to the user 108 for a communication object having a tag “Hawaii” from a member in the “Engineer”. Similarly, a tag “Vacation Destination” may be recommended to the user 108 for a communication object having a tag “Hawaii” from a member in the “Family” contact list.

As such, based on this measure of “closeness” proximity or a measure of community scope, embodiments of the invention dynamically recommend appropriate tags to communication objects based on, for example, frequency of communication between the user 108 and recipient(s). As such, although similar communication objects include the same tag “Hawaii” assigned by the sender, different recommendations may be given to the user 108 based on their affiliation to the contact list and/or frequency of communication or exchange.

Referring now to FIG. 4, a block diagram illustrates a distributed system 400 for associating various types of communication objects from one or more users via social category tags according to an embodiment of the invention. In this example, one or more server computers 402 handle or process social category tags 116 collected from one or more users. The system 400 also includes a tag database 404 which includes data associated with one or more tags used with communication objects 110. In the example in which communication objects inherit tags from related communication objects 110, the server computers 402 interact with the tag database 404 to retrieve the associated tags when processing the communication objects 110.

In an alternative embodiment, a recommendation component 406 recommends or suggests an appropriate tag to the user 108. For example, the recommendation component 406 has access to the tag database 404, and makes a recommendation or suggestion to the server computers 402 as a function of the tag content, the content of the communication objects 110, the type of the communication objects 110, the owner of the tag/communication objects, or the like. In yet another embodiment, the tag database 404 may also include a history of tags or tagging activities such that the recommendation component 406 may extract information for recommending tags to the server computers 402. Alternatively, a cache (not shown) may be used to store frequently used, accessed, applied, or assigned tags to optimize the recommendation or tagging process. Once such recommendation process is completed, the social category tags 116 are applied to the communication objects 110 to be presented to the intended recipients. In yet an alternative embodiment, the tag database 404 may be coupled with other database 412 which includes data or metadata associated with the recipient or the sender of a communication object (e.g., e-mail contact list) or the like. For example, the other database 412 may include information such as e-mail contact list, group affiliation list, frequency of correspondence between the user and other contacts, or other quantitative measures of interactions between the user and other contacts available to the user.

In another embodiment, the system 400 includes a privacy policy module (not shown) for ensuring the user's right to privacy is respected. For example, the system 400 may provide a notification to the user 108 to grant the right for the system 400 for sharing tags with other users. Once granted, the communication objects 110 with respective tag or tags are dispatched or forwarded to one or more clients 410 (e.g., communication application 106).

FIG. 5 illustrates a flow chart describing operations of associating communication objects based on the content of the communication objects according to an embodiment of the invention. At 502, one or more communication objects 110 are collected for a user (e.g., user 108). At 504, the communication application 106 receives a user instruction 510 (e.g., user input via a keyboard) for assigning a tag to a collected communication object 110. The communication application 106 further associates a subset of communication objects 110 based on the assigned tags at 506. For example, the communication application 106 associates a subset of communication objects 110 having the same tag content “PROJECT

Alternatively, embodiments of the invention include an individualistic component 512 and a social component 514 for automatically recommending or applying pre-defined tags or assigned tags to the communication objects 110 at 510. For example, the individualistic component 512 may associate a subset of communication objects 110 by extracting information or data from the communication objects 110. For example, the individualistic component 512 may extract names of individuals (e.g., e-mail message recipients), the title or subject of the communication object 110, the time or date associated with the communication object 110, the content of the communication object 110 or the like. For example, suppose a user receives an e-mail message with the content disclosing a vacation to Hawaii. The individualistic component 512 may automatically recommend or apply tags such as “vacation”, “travel”, or the like to the user, who can either approve such tag or reject the recommendation/suggestion and assign a different one, such as “Honeymoon plan A: Hawaii.”

At the same time, the social component 514 may also extract data associated with the communication object 110 to recommend, assign, or apply tags to the communication objects 110. In one example, the social component 514 determines the association by extracting the content of the communication objects 110 and also the data associated with the context relating to the communication objects 110. For example, suppose the same Hawaii e-mail message is sent to the user from his or her supervisor. Instead of assigning the tag “vacation” or “travel”, the social component 514 may recommend or suggest “seminar”, “trade expo”, “out-of-state meeting” or the like. At 508, the associated subset of communication objects 110 is presented to the user 108 and the subset includes more than one type of the communication objects 110.

In another embodiment, the social component 514 assigns category tags to communication objects 110 as a function of the content of the communication objects 110, the membership of the sender or recipients of the communication objects 110, distribution list, and/or the category tags 110 that were already assigned. In yet another alternative embodiment, the social component 514 may make category tag recommendations for a given communication objects 110 based on how others have categorized (tagged) the communication object.

For example, suppose a user receives a communication object (e.g., an e-mail message) which includes category tags assigned by other co-workers in a “Security Team”. The social component 110 may automatically recommend a “Security” tag to the user. In a similar example, the social component 514 may recommend “HR” tag to e-mail messages received from a sender who is in a human resource contact list and whose members frequently use the “HR” tag. As such, the social component 514 may automatically assign or automatically recommend category tags based on a relationship between the sender and the recipient.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for associating communication objects based on the content of the communication objects, said method comprising:
collecting communication objects for a user, said each communication object having a type describing characteristics of each said communication object;
receiving an instruction from the user for assigning a tag to each one of the collected communication objects;
associating a subset of the collected communication objects based on their assigned tags; and
presenting the associated subset of communication objects to the user such that more than one type of communication objects are included in the subset.

2. The method of claim 1, wherein the tag describing a category identifier based on the content of each communication object.

3. The method of claim 1, further comprising pre-defining tags describing a collection of known categories associated with the types of communication objects.

4. The method of claim 3, further comprising automatically recommending or applying the pre-defined tags or assigned tags to the communication object.

5. The method of claim 3, further comprising evaluating relevancy of the collected communication objects to identify related communication objects, and wherein automatically recommending or applying comprises automatically recommending or applying the assigned tags to the related communication objects.

6. The method of claim 1, wherein the type describing characteristics of the communication object comprises one of the following: an electronic mail message, a contact entry, a task item, an electronic appointment requests, a calendar event, and an instant message conversation.

7. The method of claim 1, wherein one or more computer-readable media have computer-executable instructions for performing the method of claim 1.

8. A system for associating communication objects based on the content of the communication objects, said system comprising:
an interface for collecting communication objects for a user, said each communication object having a type describing characteristics of each said communication object;
a processor configured for executing computer-executable instructions for:
receiving an instruction from the user for assigning a tag to each one of the collected communication objects;
associating a subset of the collected communication objects based on their assigned tags; and
a user interface for presenting the associated subset of communication objects to the user such that more than one type of communication objects are included in the subset.

9. The system of claim 8, wherein the tag describing a category identifier based on the content of each communication object.

10. The system of claim 8, wherein the processor is further configured to pre-defining tags describing a collection of known categories associated with the types of communication objects.

11. The system of claim 10, wherein the processor is further configured to automatically recommend or apply the pre-defined tags to the communication object.

12. The system of claim 10, wherein the processor is further configured to determine an inherency relationship among a plurality of associated subset based on the assigned tags of communication objects within each of the associated subset.

13. The system of claim of 12, wherein the processor is configured to automatically recommend or apply tags to communication objects as a function of the inherency relationship.

14. The system of claim 8, wherein the type describing characteristics of the communication object comprises one of the following: an electronic mail message, a contact entry, a task item, an electronic appointment request, a calendar event, and an instant message conversation.

15. One or more computer-readable media having stored thereon a data structure for a social category tag associated with a communication object, said communication object having a content, said data structure comprising:
a first data field including social category tag content;
a second data field including data identifying a owner of the social category tag associated with the communication object;
a third data field including data identifying the social category tag;
a fourth data field including data identifying the communication object associated with the data included in the third data field; and
a fifth data field including data identifying one or more other users associated with the data identified in the second data field.

16. The computer-readable media of claim 15, wherein the social category tag describing a category identifier based on the content of the communication object.

17. The computer-readable media of claim 15, wherein the communication object comprises one or more of the following types: an electronic mail message, a contact entry, a task item, an electronic appointment request, a calendar event, and an instant message conversation.

18. The computer-readable media of claim 17, wherein each type of the communication object comprises parameters associated with the communication object.

19. The computer-readable media of claim 18, wherein the data in each of the fifth data field comprises data relating to the one or more other users as a function of the parameters of the communication object.

20. The computer-readable media of claim 15, further comprising a sixth data field including tag association data, said tag association data being determined as a function of at least the content of the communication object and the first data field.
